(19) United States
(12) Patent Application Publication
(10) Pub. No.: US 2025/0373545 A1
(43) Pub. Date: Dec. 4, 2025

(54) USING SOURCE ROUTING FOR AUTHORIZATION

(71) Applicant: Mellanox Technologies Ltd., Yokneam (IL)

(72) Inventors: Michael TAHAR, Yavne (IL); Dmitri SHIFRIN, Beer Sheva (IL); Alex NETES, Rehovot (IL); Ortal BASHAN, Tel Aviv (IL); Ziv BATTAT, Tel Aviv (IL); Raghu KRISHNAMURTHY, San Jose, CA (US)

(73) Assignee: Mellanox Technologies Ltd., Yokneam (IL)

(21) Appl. No.: 18/676,556

(22) Filed: May 29, 2024

(51) Int. Cl. H04L 45/00

(52) U.S. Cl. CPC H04L 45/34; H04L 45/22

(57) ABSTRACT

A system and method for restricting traffic in a computer network, the method may include extracting a routing path of a packet, and determining whether to allow or block the packet based on the routing path.

### FIELD

The present disclosure relates to computer network routing, for example leveraging source routing for implementing an authorization mechanism in a computer network.

### BACKGROUND

Source routing is a routing process in a computer network where sending devices may specify the route that data packets take through a network. Source routing may allow for troubleshooting and various transmission tasks, and may be an alternative to traditional routing where packets move through the computer network based on their destination.

In InfiniBand (IB), and other types of computer networks, two source routing paths may be defined for each packet, an ongoing path (referred to as init_path in InfiniBand) and a return path. The ongoing path may refer to the path that the packet follows from the source node, through various network devices (e.g., network switches) to the destination node. The return path is what should be the ongoing path for a response packet, e.g., a packet going back from the destination node to the source node of the original packet. Typically, the return path is built by the network devices along the ongoing path.

### SUMMARY

According to embodiments of the disclosure, a system and method for restricting traffic in a computer network may include: extracting a routing path of a packet; and determining whether to allow or block the packet based on the routing path.

According to embodiments of the disclosure, the routing path may define the physical path of the packet.

According to embodiments of the disclosure, the routing path may include an ordered list of port numbers of network components in the routing path.

According to embodiments of the disclosure, the packet may an incoming packet, and the routing path may be a return path defining a path for a response packet.

According to embodiments of the disclosure, the return path may be updated by network components along an ongoing path of the packet.

According to embodiments of the disclosure, the packet may be an incoming packet, an ongoing path of the packet may be determined by a source node sending the packet, a return path of the packet may be updated by network components along the ongoing path, and extracting the routing path of the packet from the packet data may include extracting the return path of the packet.

According to embodiments of the disclosure, the packet may be an outgoing packet, an ongoing path of the packet may be determined by a source node sending the packet, and extracting the routing path of the packet from the packet data may include extracting the ongoing path of the packet.

According to embodiments of the disclosure, determining whether to allow or block the packet based on the routing path may include allowing packets that include certain routing paths and blocking packets with other routing paths.

According to embodiments of the disclosure, determining whether to allow or block the packet based on the routing path may include: applying at least one rule to the routing path; allowing the packets that conform to the at least one rule; and blocking the packets that do not conform to the at least one rule.

According to embodiments of the disclosure, a system and method for implementing an authorization mechanism in a computer network may include: determining a routing path of a packet; and allowing the packet based on the routing path.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the disclosure is particularly pointed out and distinctly claimed in the concluding portion of the specification. Embodiments of the disclosure, however, both as to organization and method of operation, together with objects, features and advantages thereof, can be understood by reference to the following detailed description when read with the accompanying drawings. Embodiments of the disclosure are illustrated by way of example and not limitation in the figures of the accompanying drawings, in which like reference numerals indicate corresponding, analogous or similar elements, and in which:

FIG. 1 depicts a high-level schematic diagram of a computer network, according to embodiments of the present disclosure.

FIG. 2 is a flowchart of a method for restricting traffic in a computer, according to embodiments of the disclosure.

FIG. 3 shows a high-level block diagram of an exemplary computing device which may be used with embodiments of the present disclosure.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of embodiments of the disclosure. However, it will be understood by those skilled in the art that the present disclosure can be practiced without these specific details. In other instances, well-known methods, procedures, and components, modules, units and/or circuits have not been described in detail so as not to obscure embodiments of the disclosure.

Embodiments of the disclosure may leverage source routing for an authorization mechanism. In source routing, the sender or source node may define or dictate the physical path of an ongoing packet, referred to herein as the ongoing path. A return path, defining a path for a response packet, may be built and updated by the network switches along the ongoing path of the ongoing packet. According to embodiments of the disclosure, the authorization mechanism may check the relevant routing path, e.g., the ongoing path or the return path, against a list of allowed or not allowed paths, and/or against a set of rules, and decide whether to allow or block the packet based on the results. Upon receiving an ongoing packet at the destination node (e.g., when the authorization mechanism operates at the destination node), the authorization mechanism may check the return path of the received ongoing packet, and upon receiving an ongoing packet at the source node (e.g., when the authorization mechanism operates at the source node), the authorization mechanism may check the ongoing path.

According to embodiments of the disclosure, the authorization mechanism may not determine whether to allow the packet or not based only on the traditional packet's fields, e.g., the destination or source address as defined in a header of the packet, but rather on the actual routing or path, meaning the physical path that the packet is going through. Thus, some embodiments of the disclosure may improve the technology of authorization mechanisms in computer networks by providing a mechanism that is not based on the configuration of the network, e.g., the routing tables, that can be changed (e.g., by a malicious entity), but on the actual physical path of the packet in the network that is harder to manipulate. In addition, and with relation to the return path, traditional authorization mechanisms may make decisions based on the source address which can be easily spoofed and manipulated, but in some embodiments the source routing path is used, and authorization may be handled by the networking devices along the way, e.g. on the path, and not by the sender, and thus can be considered as more secure.

Some practical applications of embodiments of the disclosure may include a scenario in which only one node in the network is allowed to send packets to a specific other node, and the rest of the nodes in the network are not allowed to send packets to that node. In this case, the receiving node may verify that incoming packets were originated from the allowed node according to the return path of the incoming packets. In a second scenario, some nodes and/or sub-network in a network are not allowed to communicate with other nodes. In this case, it may be defined that packets that include these nodes in the routing path will be blocked. In a third scenario, it that may be known that some ports (e.g., ports 0-30) are allocated for one kind of traffic, then it may be verified that the packet went only via these ports and not other ports since the ports are stated in the path.

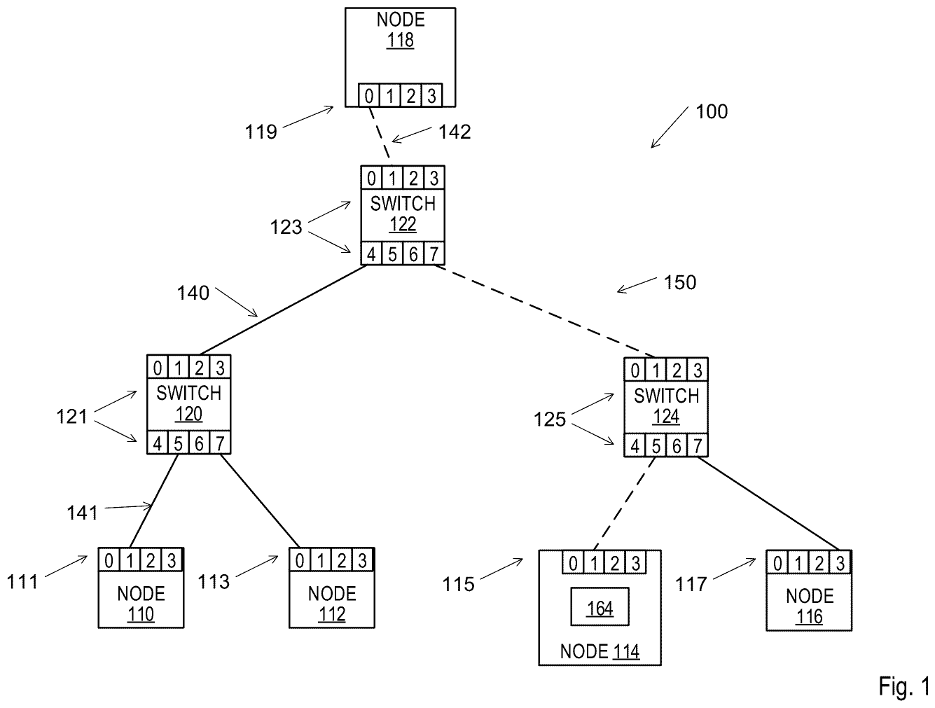

Reference is made to FIG. 1, which is a high-level schematic diagram of a computer network, according to embodiments of the disclosure. It should be readily understood that the components and functions shown in FIG. 1 are intended to be illustrative only and embodiments of the disclosure are not limited thereto.

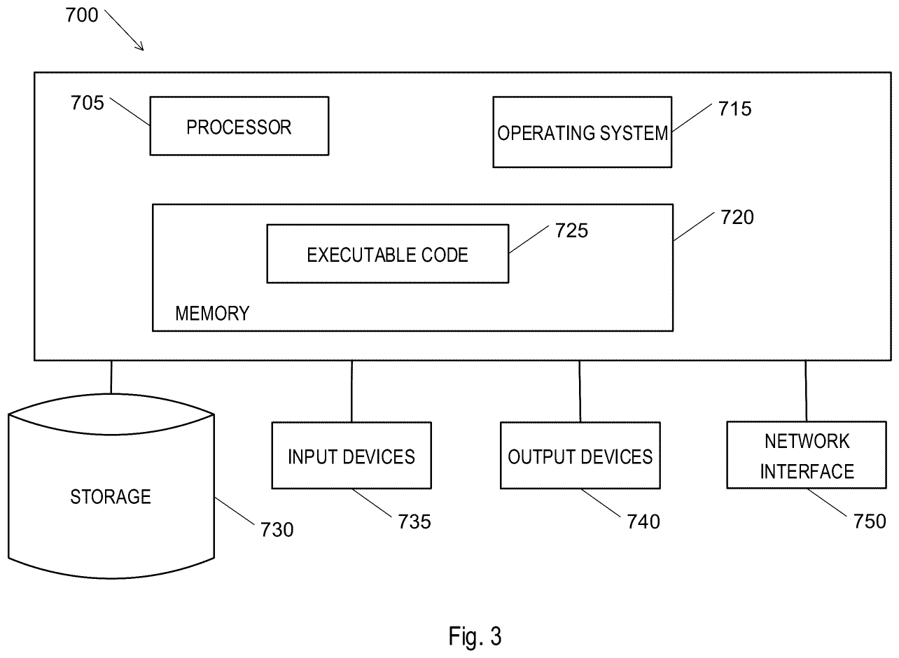

Network 100 may include any type of computer network or combination of networks. Network 100 may support communication among computing devices, referred to as nodes, such as nodes 110, 112, 114, 116 and 118 via one or more switches 120, 122 and 124. In some embodiments switches 120, 122 and 124 may form a hierarchy, in which switches 120 and 124 may form the lowest level in the hierarchy and may be connected to a node 110, 112, 114, or 116, while switch 122 may form higher level in the hierarchy and may be connected to other switches and/or routers (some or all of switches 120, 122 and 124 may also be routers). Some or all of switches 120, 122 and 124 may be or may include a computing device such as computing device 700 depicted in FIG. 3. Switches 120, 122 and 124 may be interconnected to each other by links or edges 140 and 141 (the terms links and edges may be used herein interchangeably to refer to physical layer connections between two adjacent network components) in any suitable topology.

According to some embodiments, network 100 may operate in accordance with InfiniBand (IB) specifications. Relevant features of the IB architecture are described in the InfiniBand™ Architecture Specification Volume 1 Release 1.6, published Jul. 15, 2022, or other releases, distributed by the InfiniBand Trade Association. Alternatively, network 100 may operate in accordance with other computer communication standards such as Ethernet protocol, e.g., as defined by the IEEE 802.1ah standard, and other communication schemes.

Network 100 may be implemented, for example, in data centers, high-performance compute clusters and embedded applications that may scale from two nodes 110 and 112 up to clusters utilizing thousands of nodes 110, 112, 114, 116 and 118 or more. Thus, it is noted that while only five nodes 110, 112, 114, 116 and 118 are shown in FIG. 1, this is not limiting and network 100 may be used for interconnecting a plurality of nodes 110, 112, 114, 116 or 118 to a plurality of nodes 110, 112, 114, 116 or 118. Each of nodes 110, 112, 114, 116 or 118 may be or may include a computing device such as computing device 700 depicted in FIG. 3. Each of nodes 110, 112, 114, 116 or 118 may include a network interface controller (NIC) and a processing unit such as a client, a host, a server, a CPU, a GPU, a TPU, or other computing recourses such as storage, embedded systems, etc. In some embodiments, one node 118, may be a subnet manager or other network component.

Each of nodes 110, 112, 114, 116 and 118 and switches 120, 122 and 124 (referred to herein collectively as network devices or network components 110, 112, 114, 116, 118, 120, 122 and 124) may include a plurality of ports 111, 113, 115, 117, 119, 121, 123 and 125, respectively. While network devices 110, 112, 114, 116, 118 120, 122 and 124 are shown in FIG. 1 to have 4-8 ports, this is done for illustrative purposes only, and real-world network devices may include any required number of ports, which in typical application may be tens or hundreds of ports, or more. Each one of the plurality of ports 111, 113, 115, 117, 119, 121, 123 and 125 may be identified by an identifier, e.g., a port number, unique to that port in each network device. Each of nodes 110, 112, 114, 116 and 118 may be connected to at least one of switches 120, 122 and 124 (e.g., through a NIC) via links or edges 140 and 141. Links 140 and 141 may include, for example, a wired, fiber optic, or any other type of connection. Each of links 140 and 141 may connect a specific port of a first network device 110, 112, 114, 116, 118 120, 122 and 124 to a specific port of a second network device 110, 112, 114, 116, 118 120, 122 and 124. For example, in FIG. 1, node 110 is connected to switch 120 by link 141, going from port number 1 of node 110 to port number 5 of switch 120, switch 120 is connected to switch 122 by link 140, going from port number 2 of switch 120 to port number 4 of switch 122, etc.

When a source node, e.g., node 118, sends a packet (referred to herein as an ongoing packet) to a destination node, e.g., node 114, using source routing, the source node 118 may define or dictate the routing path 150 (marked on FIG. 1 as a dashed line), in this case an ongoing path, e.g., the path that the ongoing packet should go through, from source node 118 to destination node 114. As the network topology is known at a given time, the ongoing path may be defined as a list of ongoing ports. As used herein, an ongoing port may refer to the port number from which a packet is transmitted, and an incoming port may refer to the port number in which a packet is received. Thus, the example ongoing path from source node 118 to destination node 114 may be defined by the following list of ongoing ports: port number 0 (for defining a link between node 118 and switch 122), port number 7 (for defining a link switch 122 and switch 124) and port number 5 (for defining a link switch 124 and node 114). It is noted that since each port of a first network device is connected to a specific and constant port of a second network device, a link from a first network device to the second network device may be defined by the port number in the first network device. For example, link 142 from source node 118 to switch 122 may be defined by source node 118 as including ongoing port number 0 only, without specifically mentioning incoming port number 1 of switch 122.

The return path, e.g., the path that a response packet sent back from the destination node 114 to the source node 118 should go through, may be built by the networking devices, e.g., switches 120, 122 and 124 along the ongoing path of the ongoing packet. For example, the return path from destination node 114 to source node 118, which is also routing path 150 only in a reversed direction, may include port number 1 (for defining a link between node 114 and switch 124), port number 1 (for defining a link between switch 124 and switch 122) and port number 1 (for defining a link between switch 122 and source node 118). The return path may be built by the networking devices along the ongoing path, e.g., switches 122 and 124. For example, after receiving the ongoing packet from node 118 at switch 122, switch 122 may add the incoming port of the ongoing packet, e.g., port number 1 to the return path, indicating that once a return packet (originating from node 114) is received as switch 122, the return packet should be transmitted to node 118 through port number 1. Similarly, after receiving the ongoing packet from node 118 at switch 124, switch 124 may add the incoming port number 1 to the return path 150, indicating that once a return packet (originating from node 114) is received as switch 124, the return packet should be transmitted to switch 122 through port number 1, and after receiving the ongoing packet from node 118 at node 114, node 114 may add the incoming port number 1 to the return path, indicating that once node 114 sends a return packet, the return packet should be transmitted to switch 124 from node 114 through port number 1. Thus, an ongoing path from source node 118 to destination node 114 may include port numbers 0, 7, 5, and the return path may include port numbers 1, 1, 1. Similarly, an ongoing path from source node 110 to destination node 114 may include port numbers 1, 1, 7, 5, and the return path may include port numbers 1, 1, 4, 5. Thus, routing path 150, either the ongoing path or the return path, may include an ordered list of port numbers of network devices or components in the routing path 150, that may define the physical path of the packet. Other paths with other source and destination nodes may be defined in network 100.

According to embodiment of the disclosure, network devices 110, 112, 114, 116, 118, 120, 122 and 124 may implement an authorization mechanism 164 that may restrict, e.g., block or allow, traffic in computer network 100 based on routing paths 150, e.g., based on the ongoing paths or the return paths. It is noted that while only node 114 is shown in FIG. 1 to include authorization mechanism 164, this is done for illustrative purposes only, and each of network devices 110, 112, 114, 116, 118, 120, 122 and 124 may implement such an authorization mechanism 164. According to some embodiments, authorization mechanism 164 may determine whether to allow or block a packet (e.g., an ongoing packet sent to node 114, a return packet sent from node 114 to the source node that have sent the ongoing packet, or an ongoing packet sent from node 114 to a destination node) based on the routing path, by allowing packets with certain routing paths and blocking packets with other routing paths. As used herein, allowing a packet may refer to transmitting, or allowing to be transmitted, a packet along its routing path towards its destination node. For example, for authorization mechanism 164 included in node 114, allowing an incoming (e.g., a packet received from a source node in network 100) may include forwarding the packet to node 114. Similarly, for a packet transmitted from node 114, allowing the packet may include transmitting the packet to the next network device along the relevant routing path of the packet. Likewise, blocking, or not allowing a packet may refer to not transmitting a packet along its routing path towards its destination node. For example, for authorization mechanism 164 included in node 114, blocking an incoming (e.g., a packet received from a source node in network 100) may include discarding the packet and/or not forwarding the packet to node 114. Similarly, for a packet transmitted from node 114, blocking a packet may include discarding the packet and/or not transmitting the packet to the next network device along the relevant routing path of the packet.

For example, for an ongoing packet sent from node 114 to other nodes in network 100, an ongoing path of the packet may be dictated or determined by node 114, which in this case acts as a source node. Here, authorization mechanism 164 may extract or determine the ongoing path (e.g., the ongoing path may be included in the received ongoing packet) of the ongoing packet and may determine whether to allow or block the ongoing packet based on the ongoing path.

In case node 114 acts as a destination node, node 114 may receive an ongoing packet sent from another node in network 100. As noted, a return path of the ongoing packet may be built along the ongoing path of the ongoing packet, and included in the packet data (e.g., in a header of the packet or in the packet metadata). The return path may include the routing path of a possible response packet that may be sent from node 114 back to the source node. In this case, authorization mechanism 164 may extract or determine the return path from the data of the ongoing packet received at node 114 (which is the destination node) and may determine whether to allow or block the received ongoing packet based on the return path.

Authorization mechanism 164 may check the relevant routing path, e.g., the ongoing path or the return path, against a list of allowed or not allowed paths, or against a set of rules (including one or more rules) and decide whether to allow or block the packet based on the results. For example, authorization mechanism 164 may determine whether to allow or block the packet based on the routing path by allowing packets that include a first set of routing paths and blocking packets that include a second set of routing paths. The first set of routing paths and the second set of routing paths together may form the entire set of possible routing paths. Thus, if a first set of routing paths is explicitly defined, then the second set of routing paths may include all the routing paths that are not included in the first set of routing paths, and if a second set of routing paths is explicitly defined, then the first set of routing paths may include all the routing paths that are not included in the second set of routing paths. The rules may include allowed and not allowed port numbers, or combinations of allowed and not allowed port numbers. Authorization mechanism 164 may apply one or more rules to the routing path (e.g., check whether the routing path conforms or does not conform to the one or more rules), allow the packets that conform to the one or more rules, and block or disallow the packets that do not conform to the one or more rule.

For example, when determining whether to block or allow a packet based on a list of allowed routing paths and blocked routing paths, authorization mechanism 164 may block or disallow ongoing packets received at node 114 with a return path of port numbers 1, 1, 4, 5, e.g., ongoing packets received from node 110, and may allow other ongoing packets such as ongoing packets received at node 114 with a return path of port numbers 1, 1, 4, 7, e.g., ongoing packets received from node 112, and ongoing packets received at node 114 with a return path of port numbers 1, 1, 1, e.g., ongoing packets received from node 118. An example for a rule may include “block ongoing paths that contain port number 3 as the second port number in them”. In this example, authorization mechanism 164 may block or disallow ongoing packets sent by node 114 with ongoing paths that contain port number 3 as the second port number in them, e.g., ongoing packets received at node 114 with a return path of port numbers 1, 3, 1 may be blocked. Another example for a rule may include “allow only the ongoing paths that contain port number 3 as the second port in them”. In this example, authorization mechanism 164 may allow ongoing packets sent by node 114 with ongoing paths that contain port number 3 as the second port in them and block ongoing packets sent by node 114 with ongoing paths that do not contain port number 3 in them as the second port, e.g., ongoing packets received at node 114 with a return path of port numbers 1, 3, 1 may be allowed.

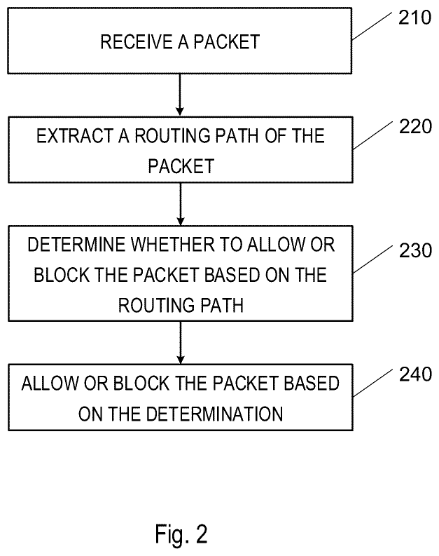

Reference is now made to FIG. 2, which is a flowchart of a method for restricting traffic in a computer network, according to embodiments of the disclosure. While in some embodiments the operations of FIG. 2 are carried out using systems as shown in FIGS. 1 and 3, in other embodiments other systems and equipment can be used.

In operation 210, a processor (e.g., processor 705 depicted in FIG. 3) may receive or obtain a packet. The processor may be located at or integrated with a network node (e.g., such as node 114 depicted in FIG. 1), that may be the source or destination of the packet. For example, the processor may be located at or integrated with a NIC of the network node. The processor may be a dedicated firewall in the network. The processor may obtain or receive an incoming packet, e.g., a packet sent from another node in the computer network, in which case the processor may be located at, integrated with or a firewall associated with the destination node of the packet, or an outgoing packet, in which case the processor may be located at, integrated with or a firewall associated with the source node of the packet that sends the packet to another node in the computer network. The processor may obtain or receive return packets as well.

In operation 220, the processor may extract or determine a routing path of the packet received or obtained in operation 210. For example, if the packet is an incoming packet, e.g., an ongoing packet originated at another source node and sent to the current node, then the processor may extract the return path of the packet, which was built or updated by network devices along the ongoing path of the incoming packet. In the case of an outgoing packet, e.g., if the packet is sent from the current node to anther destination node in the computer network, then the processor may extract the ongoing path as defined by the current node (which is the source node of the outgoing packet).

In operation 230, the processor may determine whether to allow or block the packet based on the routing path. For example, if the packet is an incoming packet, then the processor may determine whether to allow or block the packet based on the return path, and if the packet is an outgoing packet, then the processor may determine whether to allow or block the packet based on the ongoing path.

In some embodiments, the processor may determine whether to allow or block the packet based on the routing path (e.g., the ongoing path or the return path) by allowing packets with certain routing paths and blocking packets with other routing paths. Additionally or alternatively, the processor may determine whether to allow or block the packet based on the routing path (e.g., the ongoing path or the return path) by allowing packets with a routing path that conforms to, meets or triggers one or more rules and/or blocking packets with a routing path that do not conform to the one or more rules. The rules may include, for example, port numbers that must be included in the routing path, port numbers that must not be included in the routing path, and/or a combination of port numbers that must or must not be included in the routing path. Other rules may be defined. Thus, the processor may apply one or more rules to the routing path, allow the packets that conform to the one or more rules and block the packets that do not conform to the one or more rules. For example, if a rule requires that a certain port number will be included in a routing path of a packet for the packet to be allowed, then conforming to or meeting this rule implies that the routing path of a packet indeed includes that port number, and only packets with routing paths that include that specific port number are allowed. In operation 240, the processor may allow or block the packet based on the determination made in operation 230.

FIG. 3 shows a high-level block diagram of an exemplary computing device which may be used with embodiments of the present disclosure. Computing device 700 may include a controller or processor 705 that may be or include, for example, one or more central processing unit processor(s) (CPU), one or more Graphics Processing Unit(s) (GPU), a chip or any suitable computing or computational device, an operating system 715, a memory 720, a storage 730, input devices 735 and output devices 740. Each of modules and equipment such as client 120, host 130, NICs 122, 132 and switches IB0 and IB1, as shown in FIG. 1 and other modules or equipment mentioned herein may be or include, or may be executed by, a computing device such as included in FIG. 3 or specific components of FIG. 3, although various units among these entities may be combined into one computing device.

Operating system 715 may be or may include any code segment designed and/or configured to perform tasks involving coordination, scheduling, supervising, controlling or otherwise managing operation of computing device 700, for example, scheduling execution of programs. Memory 720 may be or may include, for example, a Random Access Memory (RAM), a read only memory (ROM), a Dynamic RAM (DRAM), a volatile memory, a non-volatile memory, a cache memory, or other suitable memory units or storage units. Memory 720 may be or may include a plurality of possibly different memory units. Memory 720 may store for example, instructions to carry out a method (e.g. code 725), and/or data such rules used for evaluating routing paths, data related to allowed and not allowed pates or ports, etc.

Executable code 725 may be any appropriate executable code, e.g., an application, a program, a process, task, or script. Executable code 725 may be executed by processor 705 possibly under control of operating system 715. For example, executable code 725 may when executed carry out methods according to embodiments of the present disclosure, e.g., for restricting traffic in a computer network. For the various modules and functions described herein, one or more computing devices 700 or components of computing device 700 may be used. One or more processor(s) 705 may be configured to carry out embodiments of the present disclosure by for example executing software or code.

Storage 730 may be or may include, for example, a hard disk drive, a floppy disk drive, a Compact Disk (CD) drive, or other suitable removable and/or fixed storage unit. Data such as instructions, code, telemetry data, etc. may be stored in a storage 730 and may be loaded from storage 730 into a memory 720 where it may be processed by processor 705. Some of the components shown in FIG. 3 may be omitted.

Input devices 735 may be or may include, for example a mouse, a keyboard, a touch screen or pad, or any suitable input device. Any suitable number of input devices may be operatively connected to computing device 700 as shown by block 735. Output devices 740 may include displays, speakers, and/or any other suitable output devices. Any suitable number of output devices may be operatively connected to computing device 700 as shown by block 740. Any applicable input/output (I/O) devices may be connected to computing device 700, for example, a modem, printer or facsimile machine, a universal serial bus (USB) device, or external hard drive may be included in input devices 735 or output devices 740. Network interface 750 may enable device 700 to communicate with one or more other computers or networks. For example, network interface 750 may include a wired or wireless NIC.

Embodiments of the disclosure may include one or more article(s) (e.g. memory 720 or storage 730) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the disclosure may be embodied in other specific forms using other details without departing from the spirit or essential characteristics thereof. The foregoing embodiments are therefore to be considered in all respects illustrative rather than limiting of the disclosure described herein. Scope of the disclosure is thus indicated by the appended claims, rather than by the foregoing description, and all changes that come within the meaning and range of equivalency of the claims are therefore intended to be embraced therein. In some cases well-known methods, procedures, and components, modules, units and/or circuits have not been described in detail so as not to obscure embodiments of the disclosure. Some features or elements described with respect to one embodiment can be combined with features or elements described with respect to other embodiments.

Although embodiments of the disclosure are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the disclosure are not limited in this regard, the terms “plurality” can include, for example, “multiple” or “two or more”. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A system for restricting traffic in a computer network, the system comprising:
a memory; and
a processor to:
extract a routing path of a packet; and
determine whether to allow or block the packet based on the routing path.

2. The system of claim 1, wherein the routing path defines the physical path of the packet.

3. The system of claim 1, wherein the routing path comprises an ordered list of port numbers of network components in the routing path.

4. The system of claim 1, wherein the packet is an incoming packet, and wherein the routing path is a return path defining a path for a response packet.

5. The system of claim 4, wherein the return path is updated by network components along an ongoing path of the packet.

6. The system of claim 1, wherein the packet is an incoming packet, wherein an ongoing path of the packet is determined by a source node sending the packet, wherein a return path of the packet is updated by network components along the ongoing path, and wherein the processor is configured to extract the routing path of the packet from the packet data by extracting the return path of the packet.

7. The system of claim 1, wherein the packet is an outgoing packet, wherein an ongoing path of the packet is determined by a source node sending the packet, and wherein the processor is configured to extract the routing path of the packet from the packet data by extracting the ongoing path of the packet.

8. The system of claim 1, wherein the processor is configured to determine whether to allow or block the packet based on the routing path by allowing packets with certain routing paths and blocking packets with other routing paths.

9. The system of claim 1, wherein the processor is configured to determine whether to allow or block the packet based on the routing path by:
applying at least one rule on the routing path;
allowing the packets that conform to the at least one rule; and
blocking the packets that do not conform to the at least one rule.

10. The system of claim 1, wherein the computer network is an InfiniBand computer network.

11. A method for restricting traffic in a computer network, the method comprising:
extracting a routing path of a packet; and
determining whether to allow or block the packet based on the routing path.

12. The method of claim 11, wherein the routing path defines the physical path of the packet.

13. The method of claim 11, wherein the routing path comprises an ordered list of port numbers of network components in the routing path.

14. The method of claim 11, wherein the packet is an incoming packet, and wherein the routing path is a return path defining a path for a response packet.

15. The method of claim 14, wherein the return path is updated by network components along an ongoing path of the packet.

16. The method of claim 11, wherein the packet is an incoming packet, wherein an ongoing path of the packet is determined by a source node sending the packet, wherein a return path of the packet is updated by network components along the ongoing path, and wherein extracting the routing path of the packet from the packet data comprises extracting the return path of the packet.

17. The method of claim 11, wherein the packet is an outgoing packet, wherein an ongoing path of the packet is determined by a source node sending the packet, and wherein extracting the routing path of the packet from the packet data comprises extracting the ongoing path of the packet.

18. The method of claim 11, wherein determining whether to allow or block the packet based on the routing path comprises allowing packets that include certain routing paths and blocking packets with other routing paths.

19. The method of claim 11, wherein determining whether to allow or block the packet based on the routing path comprises:
applying at least one rule to the routing path;
allowing the packets that conform to the at least one rule; and
blocking the packets that do not conform to the at least one rule.

20. A method for implementing an authorization mechanism in a computer network, the method comprising:
determining a routing path of a packet; and
allowing the packet based on the routing path.
